(19) United States
(12) Patent Application Publication
(10) Pub. No.: US 2024/0295713 A1
(43) Pub. Date: Sep. 5, 2024

(54) RECYCLING DEBRIS WHILE DEPLOYING A TUBULAR BODY

(71) Applicant: TRAXyL, Inc., Gainesville, VA (US)

(72) Inventor: Daniel R. Turner, Gainesville, VA (US)

(21) Appl. No.: 18/591,715

(22) Filed: Feb. 29, 2024

Related U.S. Application Data
(60) Provisional application No. 63/488,248, filed on Mar. 3, 2023.

(51) Int. Cl. G02B 6/50; F16L 1/028; F16L 1/06

(52) U.S. Cl. CPC G02B 6/504; F16L 1/028; F16L 1/06

(57) ABSTRACT

A method, apparatus, and system for applying for adhering a tubular body onto a paved surface. The method includes preparing a segment of the paved surface to receive the tubular body, generating debris, combining the debris with an uncured protectant to form a mixture, applying the tubular body onto the prepared segment, and applying the mixture onto the tubular body while the tubular body is on the prepared segment of the paved surface.

### PRIORITY INFORMATION

This application claims priority to U.S. Application No. 63/488,248, filed on Mar. 3, 2023, with the United States Patent and Trademark Office.

### TECHNICAL FIELD

The present disclosure relates to an apparatus and method for recycling debris while deploying a tubular body onto and/or in a surface. The disclosure also relates to a deployment system for recycling the debris and deploying the tubular body. The tubular body may be a communication line, such as a fiber optic cable, and the surface may be a paved surface, such as a roadway. This patent application claims priority to U.S. Provisional No. 63/488,248, the contents of which are incorporated herein by reference.

### BACKGROUND

Communication lines or communication cables (i.e., examples of tubular bodies) provide useful conduits to transfer information (e.g., audio, visual, etc.) using modern technology. An example of a communication line is a fiber optic cable. The deployment and installation of communication lines, however, can be challenging for several reasons. For example, communication lines may need to extend over relatively long distances to, e.g., provide telecommunications to a commercial or residential building. Additionally, the communication lines may need to be accessible (e.g., for maintenance or repairs). At the same time, however, the communication lines may need to be protected from the environment and are often preferred to be hidden from view.

The usual process for installing a communication cable over a relatively long distance may consist of extruding plastic core tubes around, e.g., fibers, helically wrapping the tubes around a central strength member, building up several layers of protective sheathing, surrounding the sheathing with a protective material (armor) such as steel, and surrounding the armor with a heavy polymer jacket. Once a cable is manufactured, it can be pulled through conduits, hung along telephone poles, and/or buried inside trenches.

Additional possibilities include what is known as “micro-trenching” (see e.g., International Patent Application Publication No. 09/935,346), where a small trench or channel is cut into the road surface or the ground. The cable is then installed within the micro-trench or channel or installed on a roadway in the layers of protective sheathing as described above. Another example is described in U.S. Patent Application Publication No. 2002/0038716 where a flat fiber conduit is used for further protection. As one of ordinary skill in the art will appreciate, reference to “micro-trenching” herein are intended to be inclusive of “nano-trenching.”

Instead of micro-trenching, a segment of paved surface may be smoothed (see e.g., U.S. Pat. No. 10,866,380, which is hereby incorporated by reference in its entirety). The cable is then applied to the smoothed segment, and a protectant is applied onto the cable. When the protectant cures, the cable is adhered to the smoothed segment and encased within the protectant. The cured recycled protectant protects the cable from damage (e.g., due to vehicle tires, weather forces, snowplows, etc.).

The process of preparing a surface to receive a cable, whether by digging a trench, a channel, micro-trenching, or smoothing the surface, can generate debris. It can be time consuming to collect the debris for disposal and expensive to dispose of it. These challenges can be especially true for concrete debris, which is a hazardous waste and therefore can be subject to regulations governing disposal. Because of the time-consuming nature of collecting debris, some vendors sweep debris to the side of the pavement instead of collecting and disposing of it. However, sweeping debris to the side of the pavement may not be possible or advisable in certain environments, e.g., flight lines on air bases. In these environments, all debris must be collected to reduce the risk of foreign object debris, which can be harmful to aircrafts. Other vendors may deploy a tubular body in three stages, by first cutting the channel, next collecting the debris, and finally deploying the tubular body in the channel.

The present disclosure can help address at least some of the problems presented by the known techniques by providing systems, apparatuses, and methods to recycle debris while deploying a tubular body, such as a communication line, onto a paved surface. The disclosed systems, apparatuses, and methods can provide a more efficient tubular body deployment process where, for example, the channel forming, cable deployment, and debris collection can be done in a single pass of the deployment apparatus. Further, the disclosed systems, apparatuses, and methods may provide a beneficial recycling of debris into a protective coating of the tubular body. This may provide several benefits including, for example, efficiently repurposing the debris or waste arising from the channel forming process to avoid having to collect, handle, and/or dispose of the debris or waste. Additionally, recycling the debris can cause the protective coating to appear more similar to the remaining portion of the paved surface, thus providing aesthetic and camouflaging benefits.

### SUMMARY

Embodiments of the present disclosure may address and overcome one or more of the above shortcomings and drawbacks by providing methods, systems, and apparatuses related to deploying a tubular body, such as a communication line, onto a paved surface.

In an example embodiment, a method for applying a tubular body onto a paved surface includes preparing a segment of the paved surface to receive the tubular body, wherein preparing the segment generates debris, combining the debris with an uncured protectant to form a mixture, applying the tubular body onto the prepared segment, and applying the mixture onto the tubular body while the tubular body is on the prepared segment of the paved surface.

Various implementations can include some, all, or none of the following features. The method can include collecting the debris before the combining of the debris with the uncured protectant. The preparing of the segment of the paved surface can include smoothing a portion of the paved surface. The preparing of the segment of the paved surface can include cutting a channel in the paved surface. The method can include curing the mixture into a cured protectant while the uncured protectant is on the tubular body on the prepared segment of the paved surface, the cured protectant protectively encasing and adhering the tubular body to the prepared segment of the paved surface. The collecting of the debris can include vacuuming the debris. The method can include blowing the prepared segment prior to applying the tubular body to the prepared segment. The method can include shaping the mixture after the applying of the mixture onto the tubular body on the prepared segment. The combining can include mixing in a catalyst. The tubular body can be a fiber optic cable. A color of the mixture can be closer to a color of the paved surface than a color of the uncured protectant is to the color of the paved surface.

In another example implementation, a method for applying a tubular body onto a paved surface includes preparing a segment of the paved surface to receive the tubular body, wherein preparing the segment generates debris, applying the tubular body onto the prepared segment of the paved surface in response to preparing the segment of the paved surface, applying uncured protectant onto the tubular body, applying the debris onto the uncured protected, and curing the uncured protectant into a cured protectant while the uncured protectant is on the tubular body on the prepared segment of the paved surface, the cured protectant protectively encasing and adhering the tubular body to the prepared segment of the paved surface.

Various implementations can include some, all, or none of the following features. The preparing of the segment of the paved surface can include smoothing a portion of the paved surface. The preparing of the segment of the paved surface can include cutting a channel in the paved surface. The method can include collecting the debris before the applying of the debris on the uncured protectant. The collecting of the debris can include vacuuming the debris. The method can include blowing the prepared segment prior to applying the tubular body to the prepared segment. The tubular body can be a fiber optic cable. The applying of the debris onto the uncured protectant can form a mixture with a color closer to a color of the paved surface than a color of the uncured protectant is to the color of the paved surface.

In an example embodiment, an apparatus for adhering a tubular body to a paved surface includes a main body movable in an advancing direction, the main body possessing a forward end and a read end, a smoothing apparatus connected to the main body, the smoothing apparatus configured to contact the paved surface at a smoothing contact point to smooth a segment of the paved surface when the apparatus moves in the advancing direction, wherein debris is generated from smoothing a segment of the paved surface, a deployment mechanism connected to the main body, the deployment mechanism configured to deploy a tubular body onto a surface, a collection mechanism connected to the main body, the collection mechanism configured to collect the debris, a mixing container connected to the main body, the mixing container configured to receive the debris and a resin, the resin being uncured when received in the mixing container, and a mixture conduit connected to the main body, the mixture conduit configured to apply a mixture of the debris and the resin of the mixing container on the surface, the mixture being applied on the surface proximal to where the tubular body is deployed onto the surface in the advancing direction so that the mixture is deployed on top of the tubular body and the surface to protectively adhere the tubular body to the surface.

Various embodiments can include some, all, or none of the following features. The apparatus can include a debris container connected to the main body, the debris container configured to selectively receive debris from the collection mechanism and expel the debris to the mixing container while maintaining a vacuum in the collection mechanism. The apparatus can include a resin container connected to the main body, the resin container configured to store a resin, the resin container in fluid communication with the mixing container such that stored resin can flow to the mixing container, wherein the mixing container further comprising a wheel configured to maintain a vacuum within the mixing container by contacting a side of the mixing container. The apparatus can include a blowing apparatus connected to the main body, the blowing apparatus configured to blow debris from an area smoothed by the smoothing apparatus prior to deployment of the tubular body. The collection mechanism can include a vacuum. The apparatus can include a shaping template comprising an opening and being positioned to contact the surface when the main body moves in the advancing direction.

In an exemplary embodiment, a method is disclosed for applying a tubular body onto a paved surface includes preparing a segment of the paved surface to receive the tubular body, wherein preparing the segment generates debris. The method further includes collecting the debris, combining the debris with an uncured protectant to form a mixture, applying the tubular body onto the prepared segment, and applying the mixture onto the tubular body while the tubular body is on the prepared segment of the paved surface.

In another embodiment, this disclosure involves an apparatus for adhering a tubular body to a paved surface. The apparatus includes a main body movable in an advancing direction. The main body possesses a forward end and a rear end. A smoothing apparatus is connected to the main body. The smoothing apparatus is configured to contact the paved surface at a smoothing contact point to smooth a segment of the paved surface when the apparatus moves in the advancing direction. Debris is generated from smoothing a segment of the paved surface. A deployment mechanism is connected to the main body. The deployment mechanism is configured to deploy a tubular body onto a surface. A collection mechanism is connected to the main body. The collection mechanism is configured to collect the debris. A mixing container is connected to the main body. The mixing container is configured to receive the debris and a resin. The resin is uncured when received in the mixing container. A mixture conduit is connected to the main body. The mixture conduit is configured to apply a mixture of the debris and the resin of the mixing container on the surface. The mixture is applied on the surface proximal to where the tubular body is deployed onto the surface in the advancing direction so that the mixture is deployed on top of the tubular body and the surface to protectively adhere the tubular body to the surface.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present disclosure are best understood from the following detailed description when read in connection with the accompanying drawings. For the purpose of illustrating the disclosed technology, there are shown in the drawings embodiments that are presently preferred, it being understood, however, that the disclosed technology is not limited to the specific instrumentalities disclosed. Included in the drawings are the following Figures:

FIG. 1A illustrates a perspective view of a tubular body encased in a recycled protectant, according to an embodiment of the disclosure.

FIG. 1B illustrates another exemplary embodiment of the tubular body being encased in a recycled protectant, according to an embodiment of the disclosure.

FIG. 2 illustrates a perspective view of debris generated by smoothing and/or cutting a segment of a surface, according to an embodiment of the disclosure.

FIG. 3 is a flow chart illustrating a method of recycling debris while deploying a tubular body, according to an embodiment of the disclosure.

FIG. 4 illustrates a perspective view of a deployment apparatus, according to an embodiment of the disclosure.

FIG. 5 illustrates a perspective view of a deployment apparatus, according to another embodiment of the disclosure.

FIGS. 6A and 6B illustrate a perspective view of a deployment apparatus, according to another embodiment of the disclosure.

FIG. 7 illustrates a perspective view of a deployment apparatus, according to another embodiment of the disclosure.

FIGS. 8A, 8B, and 8C each illustrate a cross-sectional view of a tubular body encased in a recycled protectant on a prepared surface according to an embodiment of the disclosure.

FIG. 9 is a flow chart illustrating a method of recycling debris while deploying a tubular body, according to an embodiment of the disclosure.

FIG. 10 illustrates a perspective view of a deployment apparatus, according to an embodiment of the disclosure.

### DETAILED DESCRIPTION

The present disclosure describes recycling debris while deploying a tubular body onto and/or in a surface. The surface could be a paved surface or an otherwise man-made surface. The surface could be, e.g., a parking lot, a pathway, an airport runway, or any other man-made surface. In disclosed embodiments, the systems and methods described herein utilize micro-trenching or smoothing operations, which generate less waste than convention trenching, and recycling the debris generated into the protectant that adheres the tubular body in the channel, micro-trench, or smoothed surface. Because little debris is generated by forming the channel, micro-trenching, and smoothing, in some embodiments, substantially all of the debris generated can be incorporated into the protectant, and substantially all of the protectant can be used to adhere the tubular body in the channel, micro-trench, or the smoothed surface. As a result, the systems and methods described herein teach a way of deploying a tubular body to a paved surface that results in minimal or no waste to dispose of at the end of the process.

Although certain examples of the disclosed technology are explained in detail, it is to be understood that other examples, embodiments, and implementations of the disclosed technology are contemplated. Accordingly, it is not intended that the disclosed technology is limited in its scope to the details of construction and arrangement of components set forth in the following description or illustrated in the drawings. The disclosed technology can be implemented in a variety of examples and can be practiced or carried out in various ways. In particular, the presently disclosed subject matter is described in the context of deploying a tubular body, such as a communication line, onto or into a paved surface. The present disclosure, however, is not so limited, and can be applicable to other applications. The present disclosure, for example and not limitation, can include recycling debris while deploying a tubular body, such as a communication line, onto any paved surface, including a parking lot, a pathway, an airport runway, or any other man-made surface. Such implementations and applications are contemplated within the scope of the present disclosure. Accordingly, when the present disclosure is described in the context of recycling debris while deploying a tubular body, such as a communication line, onto a paved surface, it will be understood that other implementations can take the place of those referred to.

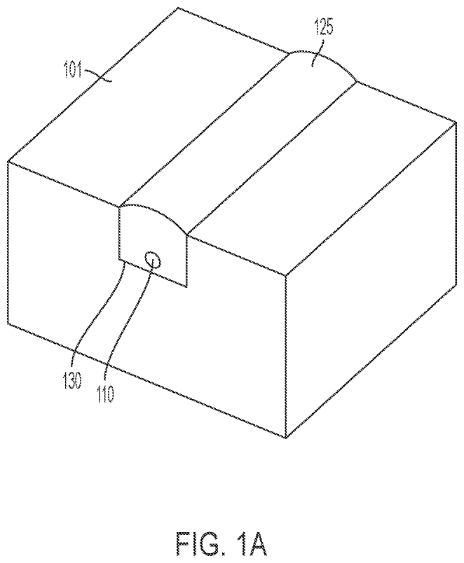

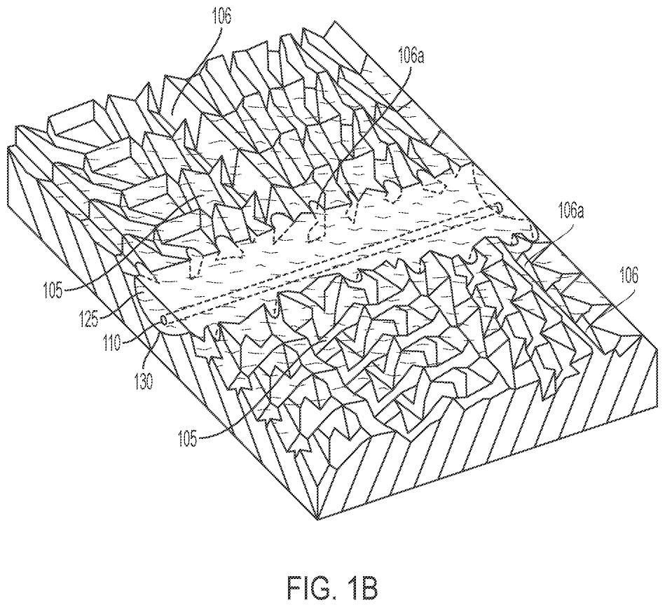

Referring now to the drawings, in which like numerals represent like elements, examples of the present disclosure are herein described. FIG. 1A illustrates a perspective view of a tubular body 110 encased in a recycled protectant 125 according to an embodiment of the disclosure. FIG. 1A illustrates the tubular body 110 and a recycled protectant 125 in a smoothed segment 130 of the paved surface 101. The smoothed segment 130 may be a smoother surface (i.e., possess less irregularities such as cracks, crevices, and protrusions) than the remaining areas of the paved surface 101 that were not smoothed or leveled, and which thus possess surface irregularities.

Many surfaces may contain irregularities such as cracks, crevices, protrusions, etc. The irregularities may be very small and may be difficult or even impossible to detect with the unaided eye (i.e., naked eye). If the paved surface 101 that receives the tubular body 110 has these irregularities, the bond between the tubular body 110 and the paved surface 101 may not be as strong (for example, a portion of the tubular body 110 may be on a protrusion of the surface and thus not be fully encased by the recycled protectant 125). Additionally, irregularities in the paved surface 101 can damage the tubular body 110, especially if the tubular body 110 is relatively small (and relatively fragile), such as a fiber optic cable.

Therefore, as explained in U.S. Pat. No. 10,866,380, which is hereby incorporated by reference in its entirety, one technique for deploying a tubular body involves smoothing a segment of the surface with a smoothing apparatus, applying the tubular body 110 onto the smoothed segment 130 of the paved surface 101 that has been smoothed, and applying an uncured recycled protectant 125a onto the tubular body 110 in the smoothed segment 130. When the uncured protectant 125a cures into a cured protectant 125b, the tubular body 110 may be firmly adhered to the smoothed segment 130 while being encased within the cured protectant 125b. The cured protectant 125b may help protect the tubular body 110 from damage (e.g., due to vehicle tires, weather forces, snowplows, etc.).

Another method of installing a tubular body 110 is sometimes referred to as “micro-trenching.” This technique is similar to a trenching or plowing install, but the cutting tool and trench or groove formed in the surface are smaller. Less filler material may also be required compared to more traditional “trenching” techniques to deploy a tubular body, such as a communication cable. The micro-trenching installation technique is typically used on roadways and often utilizes a heavy-duty diamond saw blade that cuts a narrow (e.g., a few inches wide) section of a roadway or similar surface to a predetermined depth depending on the location. A tubular body 110 can be thereafter installed into the micro-trench. Alternatively, a micro duct can be inserted into the micro-trench and then the tubular body 110 is inserted through the micro duct. In either case, after the tubular body 110 is deployed into the micro-trench, the micro-trench is backfilled with an aggregate and another acceptable material.

FIG. 1B illustrates another exemplary embodiment of the tubular body 110 being encased in a recycled protectant 125 along a smoothed segment 130 of a surface 101, according to an embodiment of the disclosure. The smoothed segment 130 may be formed by smoothing or by “micro-trenching” as explained above. FIG. 1B illustrates a perspective view of a portion of the paved surface 101. The paved surface 101 is shown in FIG. 1B to illustrate the surface irregularities 105 more prominently. These surface irregularities 105 may be much smaller than the dimensions/proportions shown in FIG. 1B, but the surface irregularities 105 can be better understood by the possibly exaggerated dimensions.

FIG. 1B also illustrates a smoothed segment 130 in the paved surface 101 similar to the smoothed segment 130 shown in FIG. 1A. The smoothed segment 130 of this embodiment, however, possesses a slightly curved shape. That is, the smoothed segment 130 is slightly curved or arc shaped. The tubular body 110 may be applied at the center of the curve or arc-shape as shown in FIG. 1B. The recycled protectant 125 may be applied on top of the tubular body 110 in the smoothed segment 130.

As will be described in further detail below, in some embodiments, the volume of recycled protectant 125 applied on the tubular body 110 within the smoothed surface 130 may be greater than the volume of the smoothed surface 130. In those embodiments, and as illustrated in FIG. 1B, excess recycled protectant 125 may be dispersed into the natural cavities 106 formed by the surface irregularities 105 such that the final cured recycled protectant can be flush with (i.e., co-planar to) the natural high points in the paved surface 101. FIG. 1B illustrates both natural cavities filled or partially filled with 106a the excess recycled protectant 125 and natural cavities not filled or partially filled 106 with the excess recycled protectant 125.

The recycled protectant can fill the natural cavities 106 by any method known in the art. For example, depending on the viscosity of the recycled protectant 125, the recycled protectant 125 may naturally flow outward from the smoothed surface 130. For another example, the excess recycled protectant 125 may form a bulge on top of the smoothed surface 130, and that bulge can be rolled over to move the excess outward from the smoothed surface 130 into the natural cavities 106.

Embodiments involving deploying the recycled protectant 125 to fill the natural cavities 106 is not limited to the smoothed surface 130 having a curved cross-section (as shown in FIG. 1B). For example, the smoothed surface 130 may have a rectangular cross-section as shown in FIG. 1A, and the recycled protectant 125 may be deployed to fill the natural cavities 106 such that the final cured recycled protectant is flush with (i.e., co-planar to) the natural high points in the paved surface 101. Other cross-section variants are also included. Similarly, embodiments involving forming the recycled protectant 125 to have a protruding portion or bulge are not limited to being utilized in conjunction with a smoothed segment 130 having any desired cross-section.

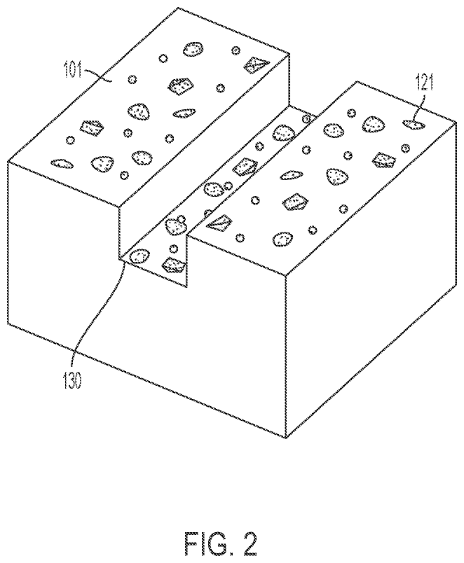

FIG. 2 illustrates a perspective view of debris 121 that can be generated by smoothing a segment of a paved surface 101 or cutting a channel or micro-trench into a segment of a paved surface 101, according to an embodiment of the disclosure. As illustrated by FIG. 2, each of forming a channel, micro-trenching, and smoothing a paved surface 101 generate debris 121. If the paved surface 101 comprises asphalt, the debris 121 can comprise dust and small particles of asphalt. If the paved surface 101 comprises concrete, the debris 121 can comprise dust and small particles of concrete. It can be time consuming to collect the debris 121 and expensive to dispose of it. This can be especially true for concrete debris 121, which is a hazardous waste and therefore can be subject to regulations governing its disposal.

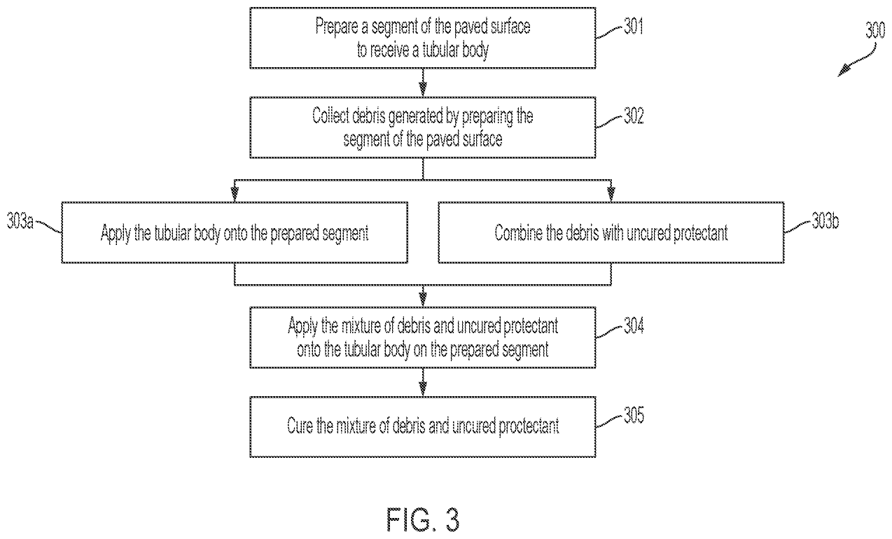

FIG. 3 is a flow chart illustrating a method of recycling debris while deploying a tubular body, according to an embodiment of the disclosure. Instead of disposing of the debris 121 generated when smoothing or cutting a micro-trench or channel, the disclosed method can incorporate the debris 121 into resin 122 that adheres the tubular body 110 to the prepared surface 102 and protectively encases it. As a result, the amount of debris 121 remaining to dispose of is minimized or eliminated altogether.

Minimizing or eliminating the amount of debris 121 requiring disposal is advantageous because it avoids the time and/or money required for collection, storage, transportation, and disposal. Repurposing the debris 121 may provide additional benefits such as minimizing waste in landfills. In addition, the recycled protectant 125 (which includes both resin 122 and debris 121) can more closely match the color of the paved surface 101 than it would without the debris 121 mixed in, which may provide aesthetic and camouflaging benefits. The method can include one or more of the steps shown in FIG. 3. These steps can be performed sequentially, or at least in some cases, simultaneously (e.g., the mixing of the resin 122 and debris 121 can occur simultaneously to the deployment of the tubular body 110). The disclosed method is not necessarily limited to any particular order or sequence of performing the steps.

At step 301, the method 300 can include preparing the paved surface 101 to receive a tubular body 110. In some embodiments, this can include smoothing a portion of the paved surface 101 to create a smoothed segment 130. In other embodiments, this can include cutting a micro-trench 130a or channel in the paved surface 101. In either embodiment, preparing the paved surface can generate debris 121 in the form of dust and small particles of the paved surface 101.

At step 302, the method 300 can include collecting the debris 121. In some embodiments, the debris 121 is vacuumed into a debris container, which can be a vacuum bag. In other embodiments, the debris 121 is collected using other known collection equipment, such as a pushing apparatus in conjunction with a collection apparatus to collect the debris 121 (e.g., using a brush or scraping apparatus to push the debris 121 into a collection receptacle) or, if the debris is magnetic, using a magnet to collect the debris 121. In some embodiments, the debris 121 can be shaken, dislodged, and/or removed from the debris container by vibrating or shaking the debris container, e.g., by providing an agitator or vibration device.

In some embodiments, the method 300 can include applying a blowing force onto the prepared surface 102 and/or surrounding area(s) prior to applying the tubular body 110 to the prepared surface 102. The blowing force can be applied after the debris 121 has been collected as described above, so that any remaining dust is removed from the prepared surface 102. Applying a blowing force to the prepared surface 102 can help facilitate a strong bond between the tubular body 110 and the prepared surface 102 by removing any remaining dust and particles from the prepared surface 102. In some embodiments, the exhaust from the vacuum performs the blowing, which can beneficially avoid the need for an additional blower and/or improve efficiency of the process. In other embodiments, a separate blower may be provided. In yet other embodiments, instead of applying a blowing force, the method 300 can include applying a vacuuming force, e.g., from a vacuum, onto the prepared surface 102 and/or surrounding area(s) prior to applying the tubular body 110 to the prepared surface 102.

At step 303a, the method 300 can include applying the tubular body 110 onto the prepared surface 102 (e.g., within a channel, trench, or smoothed segment). The tubular body 110 may be deployed using a spool and/or any other deployment mechanisms. Additional details regarding deploying a tubular body 102 onto a surface are provided in, e.g., U.S. Pat. Nos. 9,588,315 and 10,866,380, and International Application PCT/US2021/039042, each of which are incorporated herein by reference.

At step 303b, the method 300 can include combining the debris 121 with a resin 122 to form a debris-resin mixture 123. The debris-resin mixture 123 can then be combined with a catalyst 124 to form an uncured recycled protectant 125a. In some embodiments, the debris 121 can be mixed into the catalyst 124 first, and then the catalyst-debris mixture can be mixed into the resin 122. In other embodiments, the debris 121 can be mixed in simultaneous with the combination of the resin 122 and catalyst 124. Additionally, the catalyst 124 can be optionally omitted (e.g., when the resin 122 cures upon exposure to air and/or sunlight) and the uncured recycled protectant 125a may comprise only the resin 122 and debris 121.

The resin 122 is not limited to being any particular material and any material that a person skilled in the art would understand can cure to provide a protective coating is intended to be included. In some embodiments, the resin 122 can comprise methyl methacrylate (“MMA”). In other embodiments, the resin 122 can comprise an elastomer, such as polyurea. In some embodiments, the catalyst may include or be comprised of benzoyl peroxide (BPO) or dibenzoyl peroxide. Any other known or later developed catalyst that interacts with the resin to cure the resin may be utilized. In other embodiments, a hardened protective material such as concrete may be used as the resin 122, such that the debris 121 is mixed into concrete and this mixture is applied to provide the uncured recycled protectant 125a. In such embodiments, the concrete-debris mixture can harden after being applied to the paved surface 101 by being exposed to the environment (e.g., through a hydration process). The resin 122 is not limited to any particular material and may harden and/or solidify under an exothermic or endothermic reaction.

In some embodiments, the method 300 can include simultaneously vacuuming debris 121 and combining the debris 121 with a resin 122 and/or catalyst 124 in any of the manners discussed above. In some embodiments, steps 303a and 303b can occur simultaneously. In other words, the tubular body 110 can be applied to the channel, smoothed segment 130, or micro-trench 130a while the debris 121 is being mixed with the resin 122. At step 304, the method can include applying the uncured recycled protectant 125a onto the tubular body 110 while the tubular body 110 is on the prepared surface 102.

In some embodiments, all of the debris 121 generated by preparing the surface is combined with resin 122 to form the recycled protectant 125. In some embodiments, substantially all of the debris 121 generated by preparing the surface is combined with resin 122 to form the recycled protectant 125. “Substantially all” in this context is intended to mean that some nominal amounts of debris 121 can remain within the debris collection and/or mixing systems of the deployment apparatus. These remaining nominal amounts may be removed by cleaning the systems of the deployment apparatus after a deployment event is complete. Further, all or substantially all of the recycled protectant 125 can be applied onto the tubular body 110 while the tubular body 110 is on the prepared surface 102. In these embodiments, the volume of the recycled protectant 125 is greater than the volume of the channel, micro-trench 130a, or smoothed surface 130 because the volume of the recycled protectant 125 is greater than the volume of debris 121 and because the tubular body 110 occupies volume within the channel, micro-trench 130a, or smoothed surface 130. Therefore, when applying the recycled protectant 125 to the tubular body 110, the recycled protectant 125 can bulge out of (i.e., overflow) the channel, micro-trench, or smoothed surface. However, in embodiments having a small channel, micro-trench, smoothed surface, or tubular body may be so small that the bulge (i.e., overflow) is imperceptible or inconspicuous.

In some embodiments, the method 300 can further include passing the uncured recycled protectant 125a through a protectant shaping template. The protectant shaping template may shape the uncured recycled protectant 125a that bulges out of the prepared surface 102. That is, the protectant shaping template may include a hole or aperture through which the uncured recycled protectant 125a passes. The uncured recycled protectant's 125a bulge 126 may thereby be formed to take the shape of the hole or aperture of the protectant shaping template.

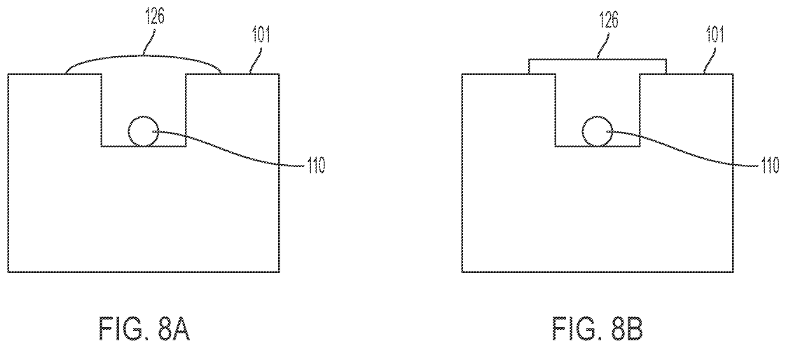

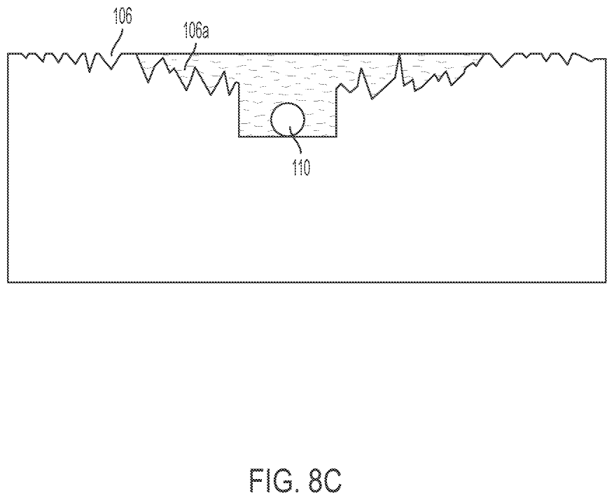

As shown in FIGS. 8A and 8B, the cross-sectional shape of the bulge 126 may be parabolic or rectangular. However, the subject matter disclosed herein is not so limited. Instead, as one of ordinary skill in the art will appreciate, many other shapes are possible. For example, the bulge may be long, flat, square, triangular, hexagonal, etc. Further, the uncured recycled protectant 125a may fill natural cavities in the prepared surface 102. In this manner, the uncured recycled protectant 125a may be dispersed into natural cavities in the prepared surface 102 such that there is no bulge 126 provided in the final cured protectant. An example of dispersing the uncured recycled protectant 125a into the natural cavities is shown in FIG. 8C. As can be seen in FIG. 8C, the final cured protectant may be flush (i.e., co-planar to) with the natural high points in the surface 100.

Returning to FIG. 3, in some embodiments, the method 300 can further include curing the uncured recycled protectant 125a so that the tubular body 110 is adhered to the prepared surface 102 and protectively encased within the recycled protectant 125. A curing lamp or arrangement of curing lamps may be used, for example, as described in International Application PCT/US2021/039042. In some embodiments, the uncured recycled protectant 125a may cure by exposure to sunlight and/or air. In some embodiments, a catalyst 124 included in the uncured recycled protectant 125a can interact with the resin 122 to facilitate curing.

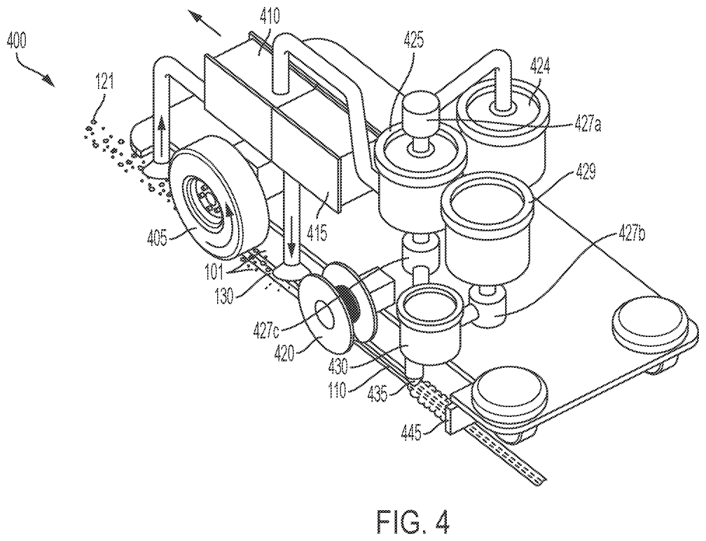

FIG. 4 illustrates a perspective view of a deployment apparatus 400, according to an embodiment of the disclosure. The deployment apparatus 400 can be configured to move along a paved surface 101 to apply a tubular body 110 onto a prepared surface 102. The tubular body 110 may be, for example, a communication line (e.g., a fiber optic cable).

In some embodiments, the deployment apparatus 400 can include a cutting mechanism 405, a collection mechanism 410, a blowing mechanism 415, a deployment mechanism 420, one or more pumps 427 and containers 424, 425, 429, 430 configured to pump and mix contents, respectively, a protectant conduit 435, and a shaping template 445. The inclusion of each of these mechanisms on a deployment apparatus 400 can allow for the trench/channel forming, debris collecting, and tubular body deploying and protecting to be performed in a single pass of the deployment apparatus 400. In other embodiments, separate apparatuses may be utilized to provide the described functionality. Providing all of the mechanisms and equipment on one deployment apparatus 400, however, can provide efficiency benefits and allow for a faster deployment of the tubular body 110.

The cutting mechanism 405 can be configured to prepare the surface to receive the tubular body 110. For example, in some embodiments, the cutting mechanism 405 can be a cutting tool configured to cut a micro-trench 130a or channel. For another example, in some embodiments, the cutting mechanism 405 can be a grinder configured to smooth the paved surface. Examples of smoothing mechanisms are illustrated and described in U.S. Pat. No. 10,866,380, incorporated herein by reference.

The collection mechanism 410 can be configured to collect the debris 121 generated by the cutting mechanism 405. For example, in some embodiments, the collection mechanism 410 can comprise a vacuum configured to vacuum the debris 121 and pull it into the debris-resin mixing container 425 to combine with a resin 122. In some embodiments, the collection mechanism 410 can further include a filter to capture larger pieces of debris 121 that will not be incorporated into the debris-resin mixture 123. In some embodiments, the collection mechanism 410 can include an agitator that can break at least some of the larger pieces of debris 121 into smaller pieces that can, e.g., pass through the filter.

The blowing mechanism 415 can be configured to blow air onto the prepared surface 102 to remove any remaining dust or small particles that could prevent a strong bond between the prepared surface 102 and the tubular body 110. In some embodiments, the vacuum's exhaust may function as the blowing mechanism 415. In some embodiments, the vacuum's exhaust is filtered by a filter 416 before exiting the system.

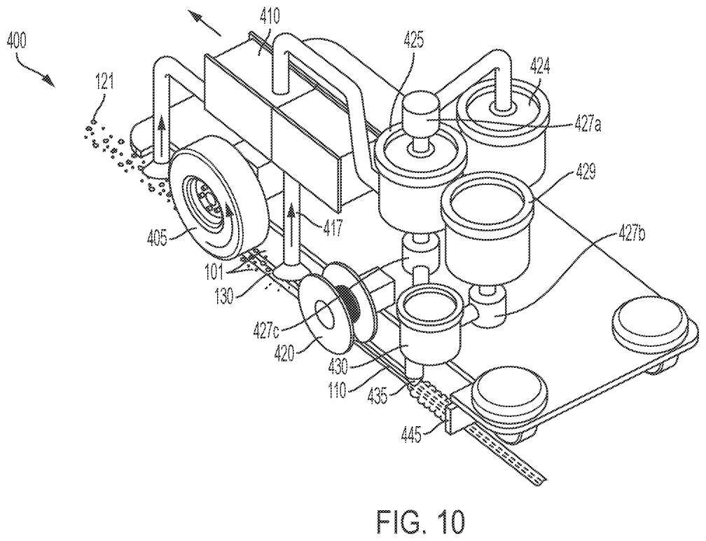

Alternatively or additionally to the blowing mechanism 415, the deployment apparatus can include a second collection mechanism 417, an embodiment of which is illustrated in FIG. 10. The second collection mechanism 417 can be configured to collect any remaining dust or small particles that could prevent a strong bond between the prepared surface 102 and the tubular body 110.

The deployment mechanism 420 can be configured to deploy the tubular body 110 onto the prepared surface 102. In some embodiments, the deployment mechanism 420 comprises a spool that holds a predetermined length of a tubular body 110 wound around the spool.

As described above, the deployment apparatus 400 can include one or more pumps 427 and containers configured to pump and mix contents, respectively. For example, in some embodiments, the deployment apparatus 400 can include a resin container 424, a debris-resin mixing container 425, catalyst container 429, and a catalyst-debris-resin mixing container 430. As one of ordinary skill in the art will appreciate, the deployment apparatus 400 can also include multiple pumps 427 to pump contents from one container to another. As one of ordinary skill in the art will also appreciate, different configurations of containers and/or pumps are within the disclosure, e.g., to introduce the debris 121 and/or catalyst 124 at a different point in the mixing process.

The resin container 424 can be configured to store resin. In some embodiments, the resin 122 can be MMA, any of the resins identified above, or any other known or later known protective materials applicable for this purpose. The debris-resin mixing container 425 can be configured to combine the debris 121 and a resin 122 to form a debris-resin mixture 123. The catalyst container 429 can be configured to store a catalyst 124 that can be configured to react with the resin 122 in the debris-resin mixture 123. The catalyst-debris-resin mixing container 430 can be configured to combine the catalyst 124 and the debris-resin mixture 123 to form an uncured recycled protectant 125a.

The protectant conduit 435 can be configured to receive the uncured recycled protectant 125a and apply it over the tubular body 110.

The shaping template 445 can be configured to shape a bulge 126 of uncured recycled protectant 125a. As illustrated in FIG. 4, as the deployment apparatus 400 moves forward, the bulge 126 of the uncured recycled protectant 125a is shaped as it passes through a hole or aperture in the shaping template 445.

In some embodiments, the deployment apparatus 400 can further include a curing device. The curing device can be configured to cure the uncured recycled protectant 125a or to increase the speed of curing the uncured recycled protectant 125a (e.g., a heat lamp can increase the speed of the curing process in some embodiments, or a blower could be used as a curing device if the uncured recycled protectant 125a uses an endothermic reaction to cure). For example, the curing device can comprise a curing lamp, a heat blanket, and/or a heat lamp. Further, for example, the curing device can emit UV rays to cure the uncured recycled protectant 125a. In some embodiments, the uncured recycled protectant 125a may cure by being exposed to the environment (e.g., air or oxygen), and so in these embodiments, the deployment apparatus 400 would not need to include the curing device. Additional details are described and illustrated regarding curing devices to cure a protective coating to protect a tubular body on a surface in U.S. Pat. Nos. 9,588,315 and 10,866,380, and International Application PCT/US2021/039042, each of which are incorporated herein by reference.

When the uncured recycled protectant 125a cures into a cured recycled protectant 125b comprising the debris 121, the tubular body 110 may be firmly adhered to the prepared surface 102 while being encased within the cured recycled protectant 125b. The cured recycled protectant 125b may help protect the tubular body 110 from damage (e.g., due to vehicle tires, weather forces, snowplows, etc.). By incorporating the debris 121 into the recycled protectant 125, the amount of debris 121 left over to dispose of after preparing the surface is minimized or eliminated altogether. Minimizing or eliminating the amount of debris 121 can be advantageous because it can avoid the time and money spent collecting, storing, transporting, and disposing of it and/or can minimize waste in landfills. In addition, the recycled protectant 125 can more closely match the color of the rest of the paved surface 101 than it would without the debris 121 mixed in, providing aesthetic and camouflaging benefits.

The components described above can be mounted on to (i.e., connected or attached to) the main body of the deployment apparatus 400. A deployment apparatus 400 may also be employed, where the different features described here are mounted on different apparatuses. One skilled in the art will recognize that different configurations and apparatuses can be used to implement the method described in this application. In some embodiments, the various mechanisms described are arranged such that the groove forming, debris collecting, tubular body deployment, and protective coating applying can be performed in a single pass of the deployment apparatus 400.

While the embodiment described above combines a debris-resin mixture 123 with a catalyst 124 to form an uncured recycled protectant 125a that is later cured, as one of ordinary skill in the art will appreciate, the subject matter disclosed herein is not so limited. Instead, in some embodiments, the resin may cure with exposure to air, obviating the need for a catalyst 124, a catalyst container 429, or a catalyst-debris-resin mixing container 430.

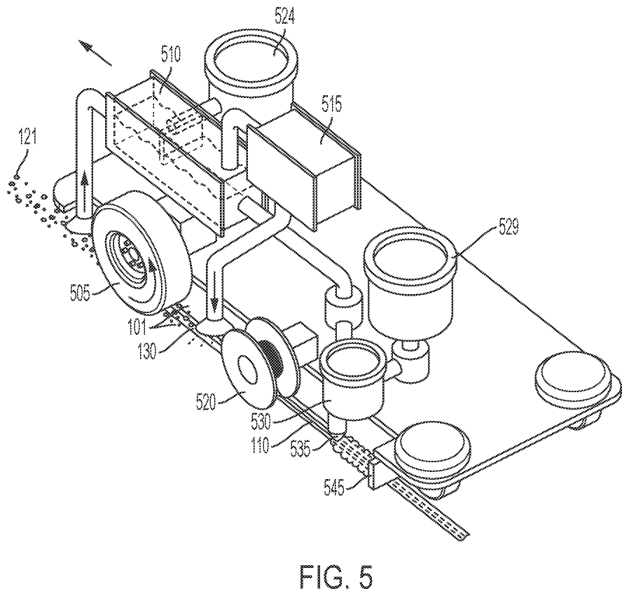

FIG. 5 illustrates a perspective view of a deployment apparatus 500, according to another embodiment of the disclosure. The deployment apparatus 500 shown in FIG. 5 utilizes a resin trap as a collection mechanism 510. In such an embodiment, the collection mechanism 510 can receive resin 122 from the resin container 524. Debris 121 can be vacuumed into the collection mechanism 510. As the debris 121 travels through the collection mechanism 510, it can mix with the resin 122 to form a debris-resin mixture 123. By using a resin trap, the deployment apparatus 500 can simultaneously maintain a vacuum to suck debris 121 into the collection mechanism 510 and deposit debris 121 in a container to mix with a resin 122.

Similar to the embodiments shown in FIG. 4, the debris-resin mixture 123 can travel to the catalyst-debris-resin mixing container 530 where the debris-resin mixture 123 can be combined with a catalyst 124 to form an uncured recycled protectant 125a. The protectant conduit 535 can receive the uncured recycled protectant 125a and apply it over the tubular body 110.

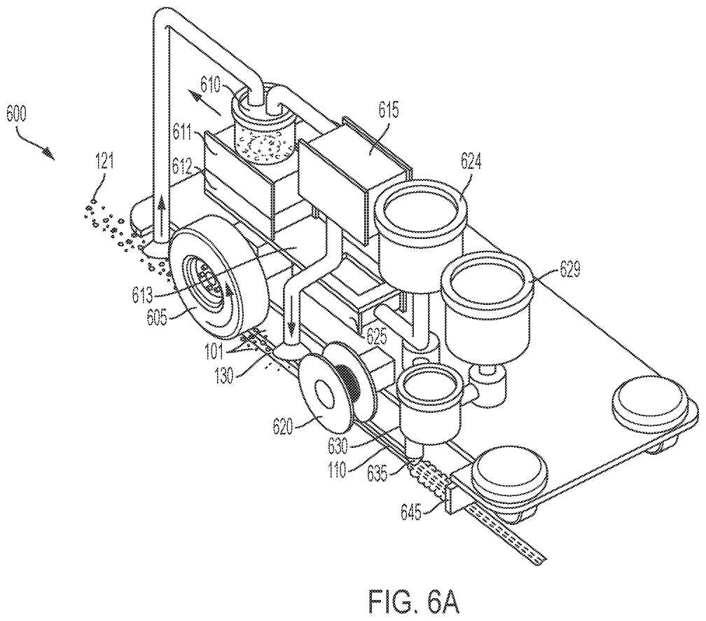

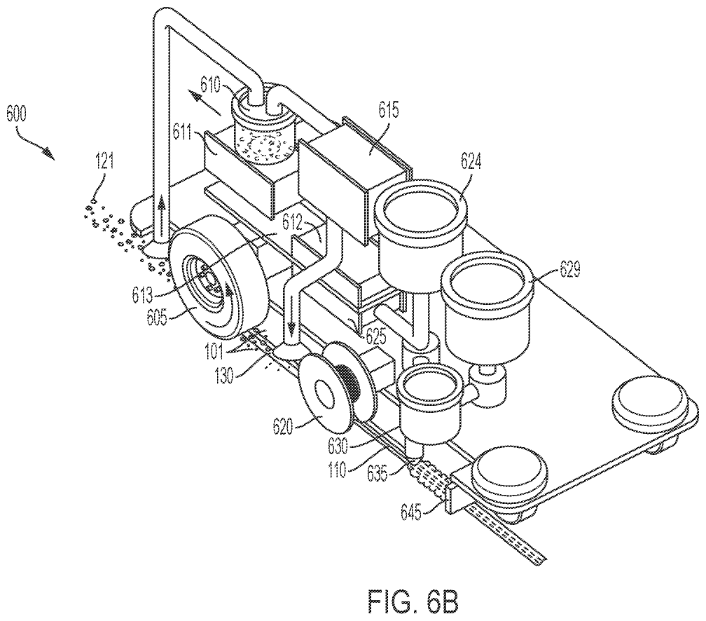

FIGS. 6A and 6B illustrate a perspective view of a deployment apparatus 600, according to another embodiment of the disclosure. The deployment apparatus 600 shown in FIGS. 6A and 6B utilizes a “sliding box” configuration. The sliding box configuration can include a collection mechanism 610, a receiving container 611, a supporting body 613, a transport container 612, and a debris-resin mixing container 625. The sliding box configuration can be configured such that debris 121 can travel from the collection mechanism 610 to the receiving container 611, for example, through one or more holes in each. From there, the debris 121 can be deposited from the receiving container 611 to the transport container 612, for example, through one or more holes in each. FIG. 6A illustrates the collection mechanism 610, the receiving container 611, and the transport container 612 aligned such that debris 121 can travel from the collection mechanism 610 to the transport container 612.

The transport container 612 can travel along the supporting body 613 until the transport container 612 is above the debris-resin mixing container 625, which can be below the supporting body 613, as illustrated in FIG. 6B. The debris 121 can travel from the transport container 612 to the debris-resin mixing container 625, for example, through one or more holes in each. From there, the debris 121 can combine with resin 122 to form a debris-resin mixture 123, as described with other embodiments disclosed herein.

By using this sliding box configuration, the deployment apparatus 600 can simultaneously maintain a vacuum to suck debris 121 into the collection mechanism 610 and deposit debris 121 from the collection mechanism 610 into a container to mix with resin 122.

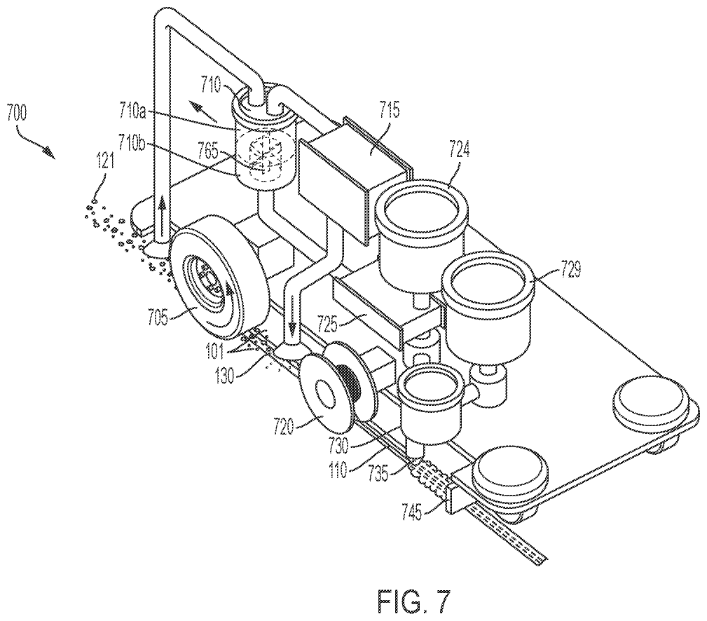

FIG. 7 illustrates a perspective view of a deployment apparatus 700, according to yet another embodiment of the disclosure. The deployment apparatus 700 in FIG. 7 utilizes a wheel 765 to maintain a vacuum in the collection mechanism 710 while debris 121 is simultaneously transferred from the collection mechanism 710 to the debris-resin mixing container 725. To illustrate, in an embodiment, the collection mechanism 710 can receive debris 121. The debris 121 can settle between spokes of the wheel 765. As the wheel 765 rotates about its axis, the debris 121 between the spokes will drop out of the spokes of the wheel 765 and travel to the debris-resin mixing container 725 where it can combine with the resin 122. In order to maintain a vacuum in the collection mechanism 710, at least two spokes of the wheel 765 maintain contact with the collection mechanism's 710 inner walls.

In the embodiment illustrated in FIG. 7, the collection mechanism 710 has an upper area 710a and a lower area 710b. The lower area 710b has a smaller internal diameter than the upper area 710a. The spokes of the wheel 765 interface with the inner walls of the lower area 710b. In this configuration, a vacuum is maintained in the upper area 710a while debris 121 is transported from the upper area 710a to the lower area 710b by the wheel 765.

Although the embodiment of a deployment apparatus 700 shown in FIG. 7 has a collection mechanism 710 having an upper area 710a with larger internal dimensions than the lower area 710b, the subject matter disclosed herein is not so limited. Instead, as one of ordinary skill in the art will appreciate, the upper area 710a may have the same or smaller internal dimensions that the lower area 710b as long as a vacuum can be maintained in the upper area 710a.

FIGS. 8A, 8B, and 8C each illustrate a cross-sectional view of a tubular body 110 encased in a recycled protectant 125 on a prepared surface 102, according to an embodiment of the disclosure. These figures illustrate some embodiments of the tubular body 110 sealed on the prepared surface 102 by the recycled protectant 125.

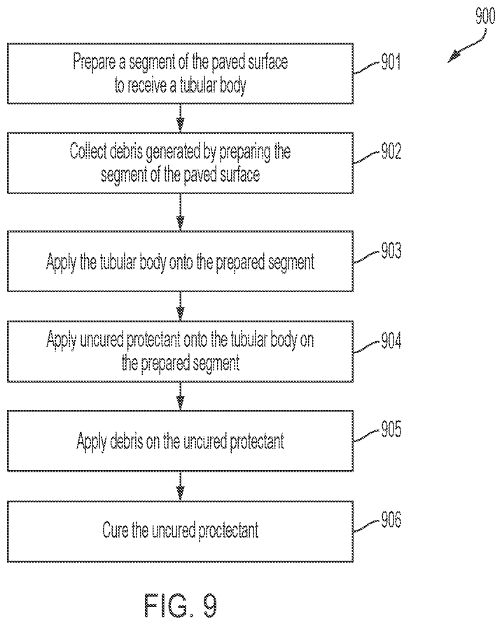

FIG. 9 is a flow chart illustrating a method 900 of recycling debris while deploying a tubular body, according to an embodiment of the disclosure. As described above with respect to FIG. 3, a method of recycling debris while deploying a tubular body can include combining the debris 121 with a resin 122 that forms a recycled protectant 125 and depositing that recycled protectant 125 onto the tubular body 110 to adhere it to the prepared surface 102 and protectively encase it. However, the subject matter disclosed herein is not so limited. Instead, a method may not include preparing a recycled protectant 125 and depositing it to the tubular body 110. Instead, as explained below with respect to FIG. 9, the method can instead include applying an uncured protectant 126a to the tubular body and applying the debris 121 on top of the uncured protectant 126a.

As with the method described above with respect to FIG. 3, the method described herein with respect to FIG. 9 can minimize or eliminate the amount of debris 121 left over to dispose of. Minimizing or eliminating the amount of debris is advantageous because it avoids the time and money spent collecting, storing, transporting, and disposing of it and will minimize waste in landfills. In addition, the cured protectant 126b will more closely match the color of the paved surface 101 because it incorporates the debris 121 generated by preparing the surface. The method can include one or more of the steps shown in FIG. 9.

At step 901, the method 900 can include preparing the paved surface 101 to receive a tubular body 110. In some embodiments, this can include smoothing a portion of the paved surface 101 to create a smoothed segment 130. In other embodiments, this can include cutting a micro-trench 130a or channel in the paved surface 101. In either embodiment, preparing the paved surface will generate debris 121 in the form of dust and small particles of the paved surface 101.

At step 902, the method 900 can include collecting the debris 121. In some embodiments, the debris 121 is vacuumed into a debris container, which can be a vacuum bag.

In some embodiments, the method 900 can include blowing the prepared surface 102 prior to applying the tubular body 110 to the prepared surface 102. Blowing the prepared surface 102 can help facilitate a strong bond between the tubular body 110 and the prepared surface 102 by removing dust and particles. In some embodiments, the exhaust from the vacuum performs the blowing.

At step 903, the method 900 can include applying the tubular body 110 onto the prepared surface 102 of the paved surface 101 in response to preparing the surface. At step 904, the method can include applying an uncured protectant 126a onto the tubular body 110 while the tubular body 110 is on the prepared surface 102.

In some embodiments, the method 900 can further include passing the uncured protectant 126a through a protectant shaping template. The protectant shaping template may shape the uncured protectant 126a that bulges out of the prepared surface 102. That is, the protectant shaping template may include a hole or aperture through which the uncured protectant 126a passes. The uncured recycled protectant's 126a bulge may thereby be formed to take the shape of the hole or aperture of the protectant shaping template.

At step 905, the method 900 can include applying the debris 121 on the uncured protectant 126a. In some embodiments, this step can include sprinkling the debris 121 onto the uncured protectant 126a. Because the protectant is uncured, the debris 121 will adhere to it.

In some embodiments, at step 906, the method 900 can further include curing the uncured protectant 126a so that the tubular body 110 is adhered to the prepared surface 102 and protectively encased.

While various exemplary embodiments of the disclosed systems, methods, and apparatuses for recycling debris while applying a tubular body have been described above, it should be understood that these exemplary embodiments have been presented for purposes of example only and are not limitations. The exemplary embodiments are not exhaustive and do not limit the disclosure to the precise form disclosed. Modifications and variations are possible in light of the above teachings or may be acquired from practicing of the disclosure, without departing from the breadth or scope.

I claim:

1. A method for applying a tubular body onto a paved surface, the method comprising:
preparing a segment of the paved surface to receive the tubular body, wherein preparing the segment generates debris;
combining the debris with an uncured protectant to form a mixture;
applying the tubular body onto the prepared segment; and
applying the mixture onto the tubular body while the tubular body is on the prepared segment of the paved surface.

2. The method of claim 1, further comprising:
collecting the debris before the combining of the debris with the uncured protectant.

3. The method of claim 1, wherein the preparing of the segment of the paved surface comprises smoothing a portion of the paved surface.

4. The method of claim 1, wherein the preparing of the segment of the paved surface comprises cutting a channel in the paved surface.

5. The method of claim 1, further comprising:
curing the mixture into a cured protectant while the uncured protectant is on the tubular body on the prepared segment of the paved surface, the cured protectant protectively encasing and adhering the tubular body to the prepared segment of the paved surface.

6. The method of claim 2, wherein the collecting of the debris comprises vacuuming the debris.

7. The method of claim 1, further comprising:
blowing the prepared segment prior to applying the tubular body to the prepared segment.

8. The method of claim 1, further comprising:
shaping the mixture after the applying of the mixture onto the tubular body on the prepared segment.

9. The method of claim 1, wherein the combining comprises mixing in a catalyst.

10. The method of claim 1, wherein the tubular body is a fiber optic cable.

11. The method of claim 1, wherein a color of the mixture is closer to a color of the paved surface than a color of the uncured protectant is to the color of the paved surface.

12. A method for applying a tubular body onto a paved surface, the method comprising:
preparing a segment of the paved surface to receive the tubular body, wherein preparing the segment generates debris;
applying the tubular body onto the prepared segment of the paved surface in response to preparing the segment of the paved surface;
applying uncured protectant onto the tubular body;
applying the debris onto the uncured protected; and
curing the uncured protectant into a cured protectant while the uncured protectant is on the tubular body on the prepared segment of the paved surface, the cured protectant protectively encasing and adhering the tubular body to the prepared segment of the paved surface.

13. The method of claim 12, wherein the preparing of the segment of the paved surface comprises smoothing a portion of the paved surface.

14. The method of claim 12, wherein the preparing of the segment of the paved surface comprises cutting a channel in the paved surface.

15. The method of claim 12, further comprising collecting the debris before the applying of the debris on the uncured protectant.

16. The method of claim 15, wherein the collecting of the debris comprises vacuuming the debris.

17. The method of claim 15, the method further comprising:
blowing the prepared segment prior to applying the tubular body to the prepared segment.

18. The method of claim 12, wherein the tubular body is a fiber optic cable.

19. The method of claim 12, wherein the applying of the debris onto the uncured protectant forms a mixture with a color closer to a color of the paved surface than a color of the uncured protectant is to the color of the paved surface.

20. An apparatus for adhering a tubular body to a paved surface, the apparatus comprising:
a main body movable in an advancing direction, the main body possessing a forward end and a read end;
a smoothing apparatus connected to the main body, the smoothing apparatus configured to contact the paved surface at a smoothing contact point to smooth a segment of the paved surface when the apparatus moves in the advancing direction, wherein debris is generated from smoothing a segment of the paved surface;
a deployment mechanism connected to the main body, the deployment mechanism configured to deploy a tubular body onto a surface;
a collection mechanism connected to the main body, the collection mechanism configured to collect the debris;
a mixing container connected to the main body, the mixing container configured to receive the debris and a resin, the resin being uncured when received in the mixing container; and
a mixture conduit connected to the main body, the mixture conduit configured to apply a mixture of the debris and the resin of the mixing container on the surface, the mixture being applied on the surface proximal to where the tubular body is deployed onto the surface in the advancing direction so that the mixture is deployed on top of the tubular body and the surface to protectively adhere the tubular body to the surface.

21. The apparatus of claim 20, further comprising a debris container connected to the main body, the debris container configured to selectively receive debris from the collection mechanism and expel the debris to the mixing container while maintaining a vacuum in the collection mechanism.

22. The apparatus of claim 20, further comprising a resin container connected to the main body, the resin container configured to store a resin, the resin container in fluid communication with the mixing container such that stored resin can flow to the mixing container, wherein the mixing container further comprising a wheel configured to maintain a vacuum within the mixing container by contacting a side of the mixing container.

23. The apparatus of claim 20, further comprising a blowing apparatus connected to the main body, the blowing apparatus configured to blow debris from an area smoothed by the smoothing apparatus prior to deployment of the tubular body.

24. The apparatus of claim 20, wherein the collection mechanism comprises a vacuum.

25. The apparatus of claim 20, further comprising a shaping template comprising an opening and being positioned to contact the surface when the main body moves in the advancing direction.
